(19) United States
(12) Patent Application Publication
(10) Pub. No.: US 2024/0367213 A1
(43) Pub. Date: Nov. 7, 2024

(54) METHOD FOR PRODUCING A CARD ELEMENT

(71) Applicant: Giesecke+Devrient ePayments GmbH, Munich (DE)

(72) Inventors: Thomas TARANTINO, Laufen (DE); Klaus KOHL, Miesbach (DE)

(21) Appl. No.: 18/649,116

(22) Filed: Apr. 29, 2024

(30) Foreign Application Priority Data
May 3, 2023 (DE) 102023111397.6

(51) Int. Cl. B21D 28/26; G06K 19/077

(52) U.S. Cl. CPC B21D 28/26; G06K 19/07722

(57) ABSTRACT

A method for producing a card element. In a step, a first material layer having a predefined card body and at least one position marking is provided. In a step, a second material layer having at least one recess extending through the second material layer is provided. In a step, the second material layer is applied onto the first material layer in such a way that the position marking in the first material layer can be optically detected through the recess extending through the second material layer. In a step, a separating device is aligned on the basis of an optically detected location of the position marking. In a step, the predefined card body is separated from the first material layer by means of the separating device so as to produce the card element.

### FIELD OF THE INVENTION

The present invention relates to the separation of metal cards from metal sheets with the use of position detection. In particular, the invention relates to a method for producing a card element.

### BACKGROUND OF THE INVENTION

Card-like data carriers are currently used in many fields of application. For example, such data carriers may be used for the cashless payment of goods or services, for personalised identification or for access to Internet-based application programs. Accordingly, there are for example card-like data carriers in the form of chip cards in general, payment cards, for example credit cards or debit cards, as well as identification or identity cards. Such card-like data carriers may be produced from metal cards, a metallic layer in the form of a metal sheet initially being provided during the production process, from which the metallic cards are then separated. Further material layers may also be laminated onto the metallic layer during production. At present, the metal cards are separated from a card laminate by means of milling technology from the metal sheet. This procedure may be time-intensive, which makes the product expensive.

### SUMMARY

It is an object of the present invention to make the process of producing card elements more efficient.

This object is achieved by the subject matter of the independent claim. Exemplary embodiments may be found in the dependent claims and the following description.

One aspect provides a method for producing a card element. In one step, the method comprises providing a first material layer having at least one predefined card body and at least one position marking. In a further step, a second material layer having at least one recess extending through the second material layer is provided. In a further step, the second material layer is applied onto the first material layer in such a way that the position marking in the first material layer can be optically detected through the recess extending through the second material layer. In a further step, a separating device is aligned on the basis of an optically detected location of the position marking. In a further step, the predefined card body is separated from the first material layer by means of the separating device so as to produce the card element.

With the production method according to the invention, it is possible to separate, in particular stamp, metal cards with positional accuracy and efficiently from a base material which is in the form of the first material layer, while avoiding the use of elaborate and time-intensive milling methods. The first material layer may be a metallic base material for producing metal cards. The first material layer may particularly be in the form of a thin metal layer, similar to a sheet metal. The first material layer may therefore also be referred to as a sheet or metal sheet. One or more position markings may be introduced into the first material layer in order to carry out accurate positioning of the separating device beforehand in relation to the first material layer with the aid of the position markings for the subsequent step of separating the card body or bodies from the first material layer, or from the sheet, which in turn allows accurately positioned separating of the card bodies from the first material layer.

The card element produced by the method according to the invention may be used as a card-like data carrier or as a starting component for the production of a card-like data carrier. Further steps may be provided for this purpose, for example the integration of a chip module into the card element, the integration of security features into the card element, etc., in order finally to produce the card-like data carrier. The latter may then be provided as a pass document, identity document, chip card or payment card.

Besides the introduction of the at least one position marking into the first material layer, the card body may also be predefined in the material layer, which may mean that the card body is already visible inside the first material layer, for example because of introduced edges which define a contour of the card body or because of other material shapings in the first material layer, which at least partially define lateral boundaries of the card body. In one example, the card body is already separated from portions of the first material layer that do not belong to the card body. One or more webs may in this case be provided, which connect the predefined card body to the portions of the first material layer that do not belong to the card body. In other words, the predefined card body may be only partially separated from the first material layer. The predefined card body may, however, also merely be predetermined by a material region of the first material layer which is subsequently separated from the first material layer by the separating device.

The one or more position markings may lie in a portion of the first material layer that does not belong to the card body, that is to say in a region of the first material layer which does not belong to the predefined card body and is therefore not subsequently separated from the first material layer. The one or more position markings may be provided as crosses, circles, lines, patterns or other shapes on or in the first material layer. The one or more position markings may be provided in the form of indentations or holes in the first material layer, or as elevations on a surface of the first material layer.

The second material layer may be applied onto the first material layer, albeit preferably only when the recess has been introduced into the second material layer. The recess may extend fully through the second material layer, for example as a hole or via. For the case in which a plurality of position markings are provided in the first material layer, a plurality of recesses may also be provided in the second material layer. It may be provided that there are at least as many recesses in the second material layer as there are position markings in the first material layer. For example, the number of position markings introduced into the first material layer is equal to the number of recesses introduced into the second material layer. Each position marking may therefore be optically detected respectively through an associated recess.

The recess or the recesses in the second layer may be used so that the position markings remain visible, and therefore optically and visually detectable, after the application of the second material layer onto the first material layer. For this purpose, the recesses may be aligned flush with the position markings while the second material layer is being applied onto the first material layer. In other words, during the application of the second material layer onto the first material layer, the two material layers may be aligned and positioned with respect to one another in such a way that the recess comes to lie over the position marking and the position marking is therefore optically and visually detectable through the recess. This is advantageous since, apart from the surface regions of the first material layer on which the position markings are located, all remaining regions of the first material layer may be covered by the second material layer. In particular, the predefined card body and its contour may be covered by the second material layer so that the location of the predefined card body can only be determined with the aid of the position markings. With the aid of the position marking(s), it is possible to ensure that the separating device can still be aligned exactly in relation to the first material layer, in particular the card bodies to be separated.

According to one embodiment, the at least one predefined card body and the at least one position marking are introduced simultaneously into the first material layer.

The generation of the predefined card body and of the position marking is therefore preferably carried out in the same process step, or simultaneously, in order to achieve the smallest possible position tolerances. The introduction of the predefined card body and of the position marking may for example be carried out by etching the first material layer, although other techniques are likewise possible.

According to one embodiment, the first material layer is a metal layer.

The method according to the invention is used in particular to produce metal cards or to produce data carriers based on metallic cards. The metal layer may be provided as a sheet metal or as a thin plate. This metal layer is also referred to here as a metal sheet, from which the predefined card body is separated in the scope of the method described herein so as to produce the card element.

According to one embodiment, the second material layer has a film-like structure.

The second material layer may be a plastic layer which is laminated onto the first material layer. A third layer may also be applied onto the first material layer. For example, the second material layer is applied onto a front side of the first material layer and the third material layer is applied onto a rear side of the first material layer, so that the second and third material layers are applied onto two opposite sides of the first material layer. It can be provided that a further material layer is applied onto the second material layer so that a plurality of, for example, film-like layers are applied on one side of the first material layer.

According to one embodiment, the application of the second material layer onto the first material layer is carried out by a lamination method.

The second material layer may therefore be connected to the first material layer by adhesion. The card body subsequently separated may furthermore comprise the laminated second material layer, so that the card element produced ultimately forms a composite of the first and second material layers and optionally further material layers.

According to one embodiment, optical detection of a location of the position marking in the first material layer is carried out in a further step of the method by means of a detection unit.

The detection unit may be an optical detection unit, for example a camera. The detection of the location may comprise detecting a position and/or an orientation of the position marking on the first material layer. The location may be determined with respect to an absolute or relative reference point, so as subsequently to align the separating device exactly in relation to the position marking and to separate the predefined card bodies, which can no longer be seen, from the first material layer with positional accuracy. The location of a card body relative to a position marking may be known, so that accurate positioning and/or alignment of the separating device over the card body to be separated may be carried out on the basis of this known location and the detected location of the position marking, in order subsequently to separate this card body from the first material layer.

According to one embodiment, the separating device is a stamping device and the separation of the predefined card body from the first material layer is carried out by stamping by means of the stamping device.

The process of producing card elements, in particular metal cards, may therefore be accelerated significantly and therefore also be made more efficient and more economical.

According to one embodiment, the position marking is introduced into a surface of the first material layer and the position marking on the surface has a first extent.

As already indicated above, the position marking may assume various shapes. The position marking may extend over a particular length, a particular diameter or a particular area on the surface of the first material layer. In any event, this length, this diameter or this area has an extent, or dimension. The extent may be measured here parallel to the surface of the first material layer.

According to one embodiment, the recess has a second extent inside the second material layer, the second extent being at least equal to or greater than the first extent.

The recess in the second material layer may likewise extend over a particular length, a particular diameter or a particular area inside the second material layer. In any event, this length, this diameter or this area has a second extent, or second dimension. The second extent may here in turn be measured parallel to a surface of the second material layer.

According to one embodiment, the position marking is arranged outside the predefined card body in the first material layer.

The position marking or the position markings may be arranged in the first material layer but located outside those regions of the first material layer which ultimately form the predefined card body, or the card element to be produced.

### BRIEF DESCRIPTION OF THE FIGURES

FIG. 1 shows a first material layer in the form of a metal sheet having a plurality of predefined card bodies and position markings.

FIG. 2 shows a material layer composite having a first, second and third material layer, as well as components for determining the location of a position marking and for aligning a separating device.

FIG. 3 shows a flowchart of a method for producing a card element.

### DETAILED DESCRIPTION OF EXEMPLARY EMBODIMENTS

The representations in the figures are schematic and not to scale. When the same reference signs are used in different figures in the following description of the figures, they denote elements which are the same or similar. Elements which are the same or similar may, however, also be denoted by different reference signs.

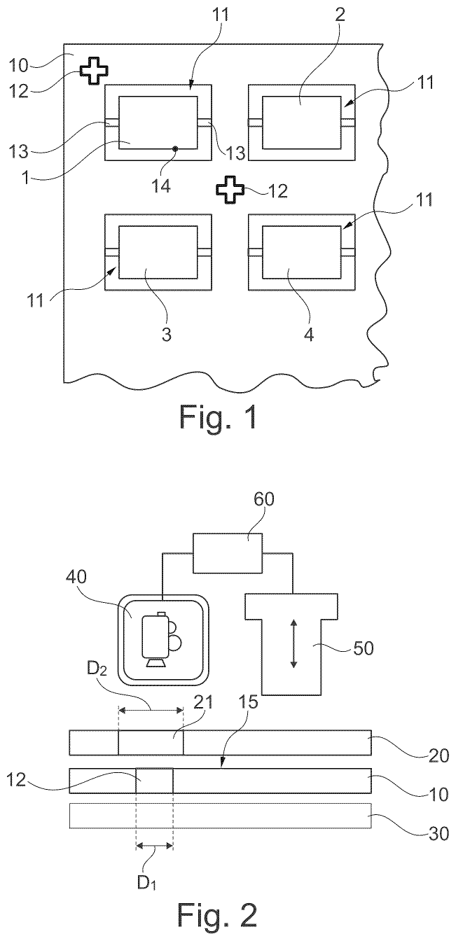

FIG. 1 shows a first material layer 10 in the form of a metal sheet having a plurality of predefined card bodies 11 and position markings 12. The metal sheet only here represents one layer in the subsequent card structure. The card bodies 11 are card-like elements and are connected to the metal sheet by metal webs 13. The dimension of a card body 11 corresponds along the edge 14 of the card body 11 to that of an ISO card. In one example, the card body 11 has an ID-1 format, ID-2 format, ID-3 format or ID-000 format. The position markings 12 are applied on the metal sheet. They may be crosses, as shown, although they may also be in any other shape, for example in the shape of circles or lines. The card bodies 11, the metal webs 13 and the remaining regions of the metal sheet may all be formed by the first material layer 10. The generation of the predefined card bodies 11 and of the position markings 12 is preferably carried out in the same process step, so that the smallest possible position tolerances result. This generation may be carried out by using an etching method.

In a subsequent step, further material layers 20, 30 are applied onto the metal sheet, for example in the form of films, onto the first material layer 10. FIG. 2 in this regard shows a material layer composite having the first material layer 10, a second material layer 20 and a third material layer 30. In the present exemplary embodiment, the second material layer 20 is laminated on a first side of the first material layer 10. The third material layer 30 is applied, or laminated, onto a second side of the first material layer 10. Only one film (material layer) per side is represented in FIG. 2, although a plurality of films per side may also be provided. All the films may be joined together by lamination to form a film composite.

Before the lamination of this film composite, however, a recess 21, or an opening 21, is introduced into the second material layer 20. This recess 21, or opening 21, may be introduced into the second material layer 20 by stamping, lasering or other technologies. The recess 21, or opening 21, is preferably larger than the position marking 12. In particular, the position marking 12 is introduced into a surface 15 of the first material layer 10, this position marking 12 having a first extent D₁, for example a diameter, a width or a length, on the surface 15. The first extent D₁ may be measured parallel to the surface 15 of the first material layer 10, as can be seen in FIG. 2. The recess 21, or opening 21, has a second extent D₂, for example a diameter, a width or a length, inside the second material layer 20, wherein the second extent D₂ may, as can likewise be seen in FIG. 2, be measured parallel to the surface 15 of the first material layer 10 or parallel to the surface of the second material layer 20. The recess 21, or opening 21, is a via in the second material layer 20 and therefore extends through the second material layer 20.

The second extent D₂ may be at least equal to or greater than the first extent D₁. In the example shown, the second extent D₂ is greater than the first extent D₁. The extent D₁ of the position marking 12 should however not be greater than the extent D₂ of the recess 21, so that the position marking 12 can be optically detected as well as possible by the detection unit 40. The detection unit 40 may detect image data, which are assigned to the position marking 12. A processor 60 may then determine location data relating to the position marking 12 from these image data, so as subsequently to determine or calculate a location of the card bodies 11 in the first material layer 10, which is covered by the second material layer 20.

In other words, the position marking 12 remains visible, that is to say optically detectable for the detection unit 40, even after the lamination of the second material layer 20 onto the first material layer 10. The position marking 12 may, in particular, be detected by a camera of the detection unit 40 in order to allow positioning of the stamping device 50 with the aid of a detected location of the position marking 12 for a subsequent stamping process. The first material layer 10, or the metal sheet, may be accurately positioned and/or aligned relative to the stamping device 50 by the optical detection of the position marking 12, so that the stamping device 50 is aligned and/or positioned accurately in relation to the position of the card bodies 11 to be stamped out. The card bodies 11 may subsequently be stamped out so as to produce the card elements 1, 2, 3, 4 (cf. FIG. 1). The stamping process is carried out here by the stamping device 50.

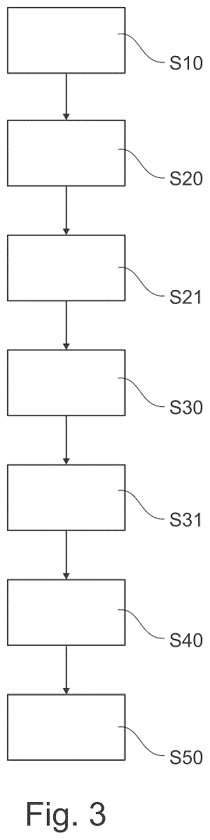

FIG. 3 shows a flowchart of a method for producing a card element, for example for producing the card element 1 of FIG. 1. In the following explanation of the method, reference will therefore also be made to FIGS. 1 and 2 which show the components and elements used in the production method.

In a step S10, a first material layer 10 having a predefined card body 11 and at least one position marking 12 is provided. In a further step S20, a second material layer 20 having at least one recess 21 extending through the second material layer 20 is provided. For this purpose, the method may furthermore comprise introducing the recess 21 into the second material layer 20 in a step S21. In a further step S30, the second material layer 20 is applied onto the first material layer 10 in such a way that the position marking 12 in the first material layer 10 can be optically detected through the recess 21 extending through the second material layer 20. In a further step S31, a location of the position marking 12 in the first material layer 10 may be optically detected by means of a detection unit 40. In a further step S40, a separating device 50 is aligned on the basis of an optically detected location of the position marking 12. In a further step S50, the predefined card body 11 is separated from the first material layer 10 by means of the separating device 50, so as to produce the card element 1. The method steps mentioned may be carried out in the order specified. The method according to the invention may inter alia increase the throughput during the production of card elements, which in turn leads to a cost reduction.

1. A method for producing a card element, comprising:
providing a first material layer having at least one predefined card body and at least one position marking;
providing a second material layer having at least one recess extending through the second material layer;
applying the second material layer onto the first material layer in such a way that the position marking in the first material layer can be optically detected through the recess extending through the second material layer;
aligning a separating device on the basis of an optically detected location of the position marking:
separating the predefined card body from the first material layer by means of the separating device so as to produce the card element.

2. The method according to claim 1, wherein the at least one predefined card body and the at least one position marking are introduced simultaneously into the first material layer.

3. The method according to claim 1, wherein the first material layer is a metal layer.

4. The method according to claim 1, wherein the second material layer has a film-like structure.

5. The method according to claim 1, wherein the application of the second material layer onto the first material layer is carried out by a lamination method.

6. The method according to claim 1, furthermore comprising:
optically detecting a location of the position marking in the first material layer by means of a detection unit.

7. The method according to claim 1, wherein the separating device is a stamping device and the separation of the predefined card body from the first material layer is carried out by stamping by means of the stamping device.

8. The method according to claim 1, wherein the position marking is introduced into a surface of the first material layer and the position marking on the surface has a first extent.

9. The method according to claim 8, wherein the recess has a second extent inside the second material layer;
wherein the second extent is at least equal to or greater than the first extent.

10. The method according to claim 1, wherein the position marking is arranged outside the predefined card body in the first material layer.
